(19) United States
(12) Patent Application Publication
(10) Pub. No.: US 2025/0346044 A1
(43) Pub. Date: Nov. 13, 2025

(54) INKJET PRINTER

(71) Applicant: Roland DG Corporation, Hamamatsu-shi (JP)

(72) Inventors: Kazuya MORIZONO, Hamamatsu-shi (JP); Bunji SHINOMIYA, Hamamatsu-shi (JP); Kazuaki AGATA, Hamamatsu-shi (JP)

(21) Appl. No.: 19/278,120

(22) Filed: Jul. 23, 2025

Related U.S. Application Data
(63) Continuation of application No. PCT/JP2024/001988, filed on Jan. 24, 2024.

(30) Foreign Application Priority Data
Jan. 24, 2023 (JP) 2023-008628

(51) Int. Cl. B41J 2/175; B41J 2/01

(52) U.S. Cl. CPC B41J 2/17596; B41J 2/17503; B41J 2002/012

(57) ABSTRACT

An inkjet printer includes an ink container, a liquid pump, an ink head, an intermediate container including a storage chamber to temporarily store ink, and a pressure sensor to measure an ink pressure in the storage chamber. The inkjet printer has registered therein a first threshold value, and a second threshold value greater than the first threshold value, for the ink pressure. The inkjet printer is configured to drive the liquid pump when the ink pressure falls below the first threshold value, and stop the liquid pump when the ink pressure exceeds the second threshold value.

### CROSS REFERENCE TO RELATED APPLICATIONS

This application claims the benefit of priority to Japanese Patent Application No. 2023-008628 filed on Jan. 24, 2023 and is a Continuation Application of PCT Application No. PCT/JP2024/001988 filed on Jan. 24, 2024. The entire contents of each application are hereby incorporated herein by reference.

### BACKGROUND OF THE INVENTION

### 1. Field of the Invention

The present invention relates to inkjet printers.

### 2. Description of the Related Art

Inkjet printers that perform printing by ejecting ink from an ink head have been known in the art. For example, JP 2020-142377 A discloses an inkjet printer including an ink cartridge that stores ink, an ink head that ejects ink, an ink channel that connects the ink cartridge and the ink head, a damper provided in the ink channel that temporarily stores ink, and a liquid pump provided in the ink channel that pumps ink to the ink head.

In the inkjet printer described in JP 2020-142377 A, the damper includes a damper membrane that expands and contracts in response to the pressure of ink in the storage chamber, a filler that moves in response to the movement of the damper membrane, and a sensor that detects the filler. The inkjet printer disclosed in JP 2020-142377 A detects whether the ink pressure has fallen below a predetermined pressure based on whether the sensor is detecting the filler. The sensor sends a signal when the ink pressure falls below a predetermined pressure. The inkjet printer drives the liquid pump to supply ink to the damper when the signal is received. The inkjet printer stops the liquid pump when the signal stops.

JP 2006-021380 A discloses an inkjet printer that determines whether the amount of ink in the damper is less than or equal to a predetermined amount by using a membrane detection sensor to detect the position of the damper membrane, and an inkjet printer that determines whether the amount of ink in the damper is less than or equal to a predetermined amount by measuring the ink pressure between the damper and the recording head using a pressure sensor.

### SUMMARY OF THE INVENTION

With the control, as disclosed in JP 2020-142377 A, of driving the liquid pump when the ink pressure in the damper falls below a predetermined pressure, and stopping the liquid pump when the ink pressure exceeds the predetermined pressure, the ink pressure may exceed the predetermined pressure immediately after the liquid pump is driven and the ink pressure may fall below the predetermined pressure immediately after the liquid pump is stopped. Therefore, a problem may occur in which the liquid pump is repeatedly driven and stopped at short intervals.

Example embodiments of the present invention provide inkjet printers that are each less prone to a problem in which the liquid pump is repeatedly driven and stopped at short intervals.

An inkjet printer according to an example embodiment of the present disclosure includes an ink container to contain ink, an ink head to eject ink, an ink channel to connect the ink container and the ink head, a liquid pump provided along the ink channel to pump ink in a direction from the ink container toward the ink head when driven, an intermediate container provided downstream of the liquid pump along the ink channel and including a storage chamber to temporarily store ink, a pressure sensor to measure an ink pressure in the storage chamber, and a controller that is connected to the ink head, the liquid pump, and the pressure sensor. The controller is configured or programmed to include a first liquid pump control section, a pressure acquisition section, and registration section. The pressure acquisition section is configured or programmed to acquire the ink pressure in the storage chamber from the pressure sensor. The registration section is configured or programmed to have registered therein, a first threshold value, and a second threshold value greater than the first threshold value, for the pressure acquired by the pressure acquisition section. The first liquid pump control section is configured or programmed to control the liquid pump. The first liquid pump control section is configured or programmed to drive the liquid pump when the pressure acquired by the pressure acquisition section falls below the first threshold value, and to stop the liquid pump when the pressure acquired by the pressure acquisition section exceeds the second threshold value.

With the inkjet printer described above, after the liquid pump is driven as a result of the acquired pressure falling below the first threshold value, the liquid pump will not be stopped until the pressure exceeds the second threshold value, which is greater than the first threshold value. Also, after the liquid pump is stopped as a result of the acquired pressure exceeding the second threshold value, the liquid pump will not be driven until the pressure falls below the first threshold value, which is smaller than the second threshold value. Therefore, it is possible to reduce or prevent the problem in which the liquid pump is repeatedly driven and stopped at short intervals.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 shows a front view of a printer according to an example embodiment of the present invention.

FIG. 2 shows a plan view schematically showing the configuration of the bottom surface of the carriage.

FIG. 3 shows a schematic diagram showing the configuration of the ink supply system.

FIG. 4 shows a block diagram of the printer.

FIG. 5 shows a time chart showing the ink pressure in the damper and the operation of the liquid pump.

FIG. 6 shows a time chart showing the ink pressure in the damper and the operation of the liquid pump when an ink end state is reached.

### DETAILED DESCRIPTION OF THE EXAMPLE EMBODIMENTS

Ink jet printers according to example embodiments will now be described with reference to the drawings. Note that the example embodiments described herein are not intended to limit the scope of the present invention. The same reference signs denote members/parts of the same functions, and redundant descriptions will be omitted or simplified as appropriate. In the following description, when the inkjet printer is viewed from the front, the direction away from the inkjet printer will be referred to as forward, and the direction toward the inkjet printer will be referred to as rearward. The designations F, Rr, L, R, U, and D, as used in the figures, refer to front, rear, left, right, up, and down, respectively. Note however that these directions are merely for the purpose of discussion, and should not be construed as limiting how the inkjet printer is installed, etc.

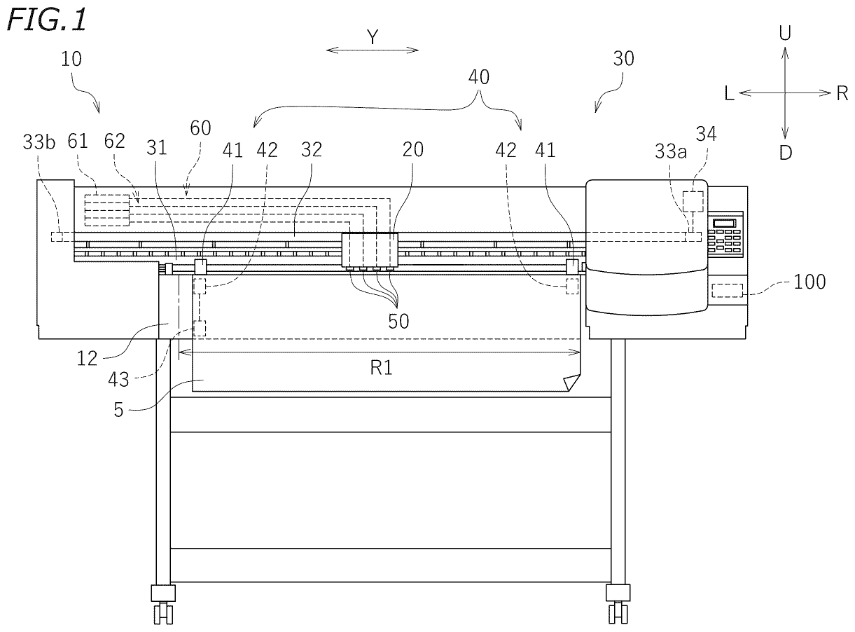

FIG. 1 is a front view of a large-format inkjet printer (hereinafter referred to as “printer”) 10 according to an example embodiment. The printer 10 prints an image on a recording medium 5 by moving a roll of the recording medium 5 in the front-rear direction and ejecting ink from ink heads 50 mounted on a carriage 20 that moves in the left-right direction.

The recording medium 5 is an object on which an image is printed. There is no particular limitation on the recording medium 5. The recording medium 5 may be, for example, paper such as plain paper or inkjet printing paper, or a transparent sheet such as a resin sheet or a glass sheet. The recording medium 5 may also be a sheet made of metal or rubber. It may also be a cloth.

As shown in FIG. 1, the printer 10 includes the carriage 20, a carriage moving device 30, a transfer device 40, the ink heads 50, an ink supply system 60, and a controller 100.

The carriage moving device 30 moves the carriage 20 in the scanning direction Y, thus moving the ink heads 50 mounted on the carriage 20 in the scanning direction Y. The scanning direction Y herein is the left-right direction. Note however that the scanning direction Y is not limited to the left-right direction. The carriage movement device 30 includes a guide rail 31, a belt 32, left and right pulleys 33a and 33b, and a carriage motor 34. The carriage 20 is slidably engaged with the guide rail 31. The guide rail 31 extends in the left-right direction. The guide rail 31 guides the movement of the carriage 20 in the left-right direction. The belt 32 is fixed to the carriage 20. The belt 32 is an endless belt. The belt 32 is wrapped around the pulley 33a provided on the right side of the guide rail 31 and the pulley 33b provided on the left side of the guide rail 31. The carriage motor 34 is mounted on the right-side pulley 33a. The carriage motor 34 is electrically connected to controller 100. The carriage motor 34 is controlled by the controller 100. When a carriage motor 34 is driven, the pulley 33a rotates, causing the belt 32 to move. As a result, the carriage 20 moves in the left-right direction along guide rail 31.

A platen 12 is disposed downward of the carriage 20. The platen 12 extends in the left-right direction. The recording medium 5 is placed on the platen 12. The printer 10 has a printable range R1, set with respect to the scanning direction Y, over which an image can be formed by ink ejected from the ink heads 50. The printable range R1 is herein from a point slightly rightward of the left end of the platen 12 to a point slightly leftward of the right end of the platen 12. The printable range R1 is set slightly inward relative to the opposite ends of the platen 12 in the scanning direction Y.

The recording medium 5 on the platen 12 is moved in the front-rear direction by the transfer device 40. The direction of transfer of the recording medium 5 is perpendicular to the scanning direction Y. The transfer device 40 includes pinch rollers 41, grit rollers 42, and a feed motor 43. The pinch rollers 41 are provided upward of the platen 12 and presses the recording medium 5 from above. The pinch rollers 41 are disposed rearward of the carriage 20. The grit rollers 42 are provided on the platen 12. The grit rollers 42 are disposed downward of the pinch rollers 41. The grit rollers 42 are provided at a position opposing the pinch rollers 41. The grit rollers 42 are linked to the feed motor 43. The grit rollers 42 are rotatable by receiving driving force from the feed motor 43. The feed motor 43 is electrically connected to the controller 100. The feed motor 43 is controlled by the controller 100. When the grit rollers 42 rotate with the recording medium 5 sandwiched between the pinch rollers 41 and the grit rollers 42, the recording medium 5 is transferred in the front-rear direction.

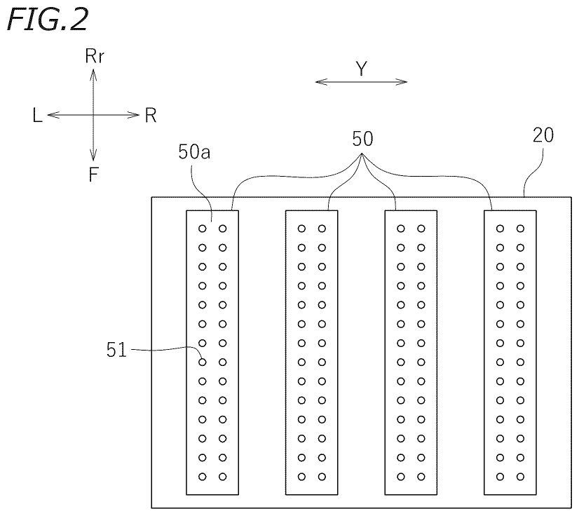

FIG. 2 is a plan view schematically showing the configuration of the bottom surface of the carriage 20. As shown in FIG. 2, a plurality of ink heads 50 are provided on the bottom surface of the carriage 20. The ink heads 50 are configured to eject ink. A plurality of ink heads 50 are disposed in a row in the scanning direction Y on the carriage 20. A plurality of nozzles 51 are located on the bottom surface of each of the plurality of ink heads 50. The nozzles 51 are minute apertures through which ink is ejected. Each of the bottom surfaces of the ink heads 50 defines a nozzle surface 50a on which a plurality of nozzles 51 are provided. At the nozzle surface 50a, a plurality of nozzles 51 are arranged in the front-rear direction to form nozzle rows. Here, two nozzle rows are provided on each ink head 50. Note however that the arrangement of the ink heads 50 and the nozzles 51 is not limited to the above. The ink heads 50 are piezo-driven inkjet heads in the present example embodiment. However, the method by which the ink heads 50 eject ink is not limited to the piezo-driven method, but may be, for example, a thermal method, etc.

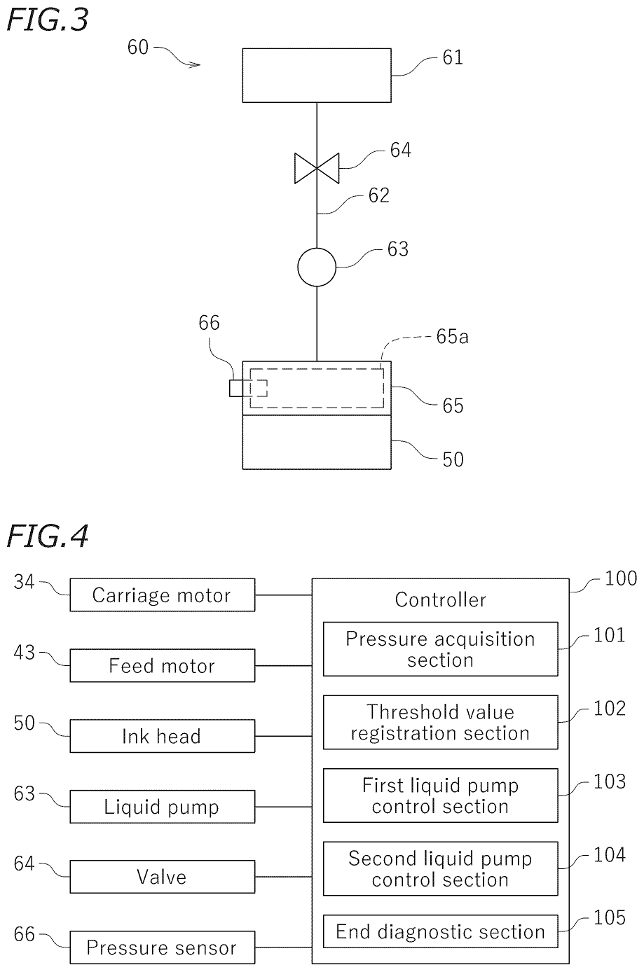

As shown in FIG. 1, ink is supplied to the ink heads 50 by the ink supply system 60. FIG. 3 is a schematic diagram showing the configuration of the ink supply system 60. In the present example embodiment, the ink supply system 60 is provided for each nozzle row. As shown in FIG. 3, each ink supply system 60 includes an ink cartridge 61, an ink channel 62, a liquid pump 63, a valve 64, and a damper 65.

The ink cartridge 61 is an example of an ink container that contains ink. One ink cartridge 61 stores one type of ink selected from among process color ink and specialty ink, for example. There is no limitation on the material of ink, and various materials that have been used in the art as materials of ink for inkjet printers may be used. The ink may, for example, be solvent-based pigment ink or water-based pigment ink. Alternatively, it may be water-based dye ink or UV-curable pigment ink that cures upon exposure to ultraviolet light.

The ink channel 62 connects the ink cartridge 61 and the ink head 50. Ink is supplied from the ink cartridge 61 to the ink head 50 through the ink channel 62. While there is no limitation on the configuration of the ink channel 62, it may include a flexible tube, for example.

The liquid pump 63 is provided in the ink channel 62. The liquid pump 63 is configured to pump ink in a direction from the ink cartridge 61 toward the ink heads 50 when driven. In the present example embodiment, the liquid pump 63 is a tube pump. Note however that there is no limitation on the type of liquid pump 63, and it may be a diaphragm pump, for example. Although not shown in the figure, the liquid pump 63 includes an internal channel formed by a flexible tube, a roller that squeezes the internal channel, and a motor that moves the roller along the internal channel. The liquid pump 63 squeezes the internal channel by driving the motor to move the roller along the internal channel, thus discharging ink from the internal channel. The liquid pump 63 is electrically connected to the controller 100 and controlled by the controller 100.

The valve 64 is provided at a portion of the ink channel 62 that is between the ink cartridge 61 and the liquid pump 63. The valve 64 opens or closes the ink channel 62. The valve 64 is, for example, a solenoid valve. Note however that there is no limitation on the type of the valve 64, and may be an air-driven valve, for example. The valve 64 is electrically connected to the controller 100 and controlled by the controller 100.

The damper 65 is provided downstream relative to the liquid pump 63 in the ink supply direction along the ink channel 62. The damper 65 is provided between the liquid pump 63 and the ink head 50. The damper 65 is an example of the intermediate container including a storage chamber 65a that temporarily stores ink. The damper 65 mitigates fluctuations in ink pressure by temporarily storing ink in the storage chamber 65a.

The damper 65 is provided with a pressure sensor 66 that measures the pressure of the ink in the storage chamber 65a. The pressure sensor 66 is a sensor that continuously measures the ink pressure. The pressure sensor 66 is, for example, a pressure sensor utilizing the piezoelectric effect of a piezoelectric element. The pressure sensor 66 is configured to output a current or voltage (hereinafter referred to also as a signal) corresponding to the measured ink pressure. The controller 100 acquires the ink pressure in the damper 65 by receiving the signal output from the pressure sensor 66.

FIG. 4 is a block diagram of the printer 10 according to the present example embodiment. As shown in FIG. 4, the controller 100 is individually electrically connected to the carriage motor 34, the feed motor 43, the ink head 50, the liquid pump 63, and the valve 64, and is configured or programmed to be capable of controlling these structural elements. The controller 100 is electrically connected to the pressure sensor 66 and receives signals from the pressure sensor 66.

There is no particular limitation on the configuration of the controller 100. The controller 100 is, for example, a microcomputer. While there is no particular limitation on the hardware configuration of the microcomputer, it includes, for example, an interface (I/F) configured or programmed to receive print data, etc., from an external device such as a host computer, a central processing unit (CPU) configured or programmed to execute instructions of the control program, a ROM (read only memory) to store programs executed by the CPU, a RAM (random access memory) used as a working area to expand the program, and a storage device such as a memory to store the program and various data. Note that the controller 100 does not always need to be installed inside the printer 10, but may be, for example, a computer, etc., installed outside the printer 10 and communicably connected to the printer 10 via a wired or wireless connection.

As shown in FIG. 4, the controller 100 is configured or programmed to include a pressure acquisition section 101, a threshold value registration section 102, a first liquid pump control section 103, a second liquid pump control section 104, and an end diagnosis section 105. The controller 100 may be configured or programmed to include processing sections other than those mentioned above, but these are not herein illustrated or described.

The pressure acquisition section 101 is configured or programmed to acquire the pressure of the ink in the storage chamber 65a of the damper 65 from the pressure sensor 66. The pressure acquisition section 101 is configured or programmed to acquire the pressure of the ink in the storage chamber 65a by reading the value (e.g., voltage) of the signal corresponding to the pressure of the ink transmitted from the pressure sensor 66.

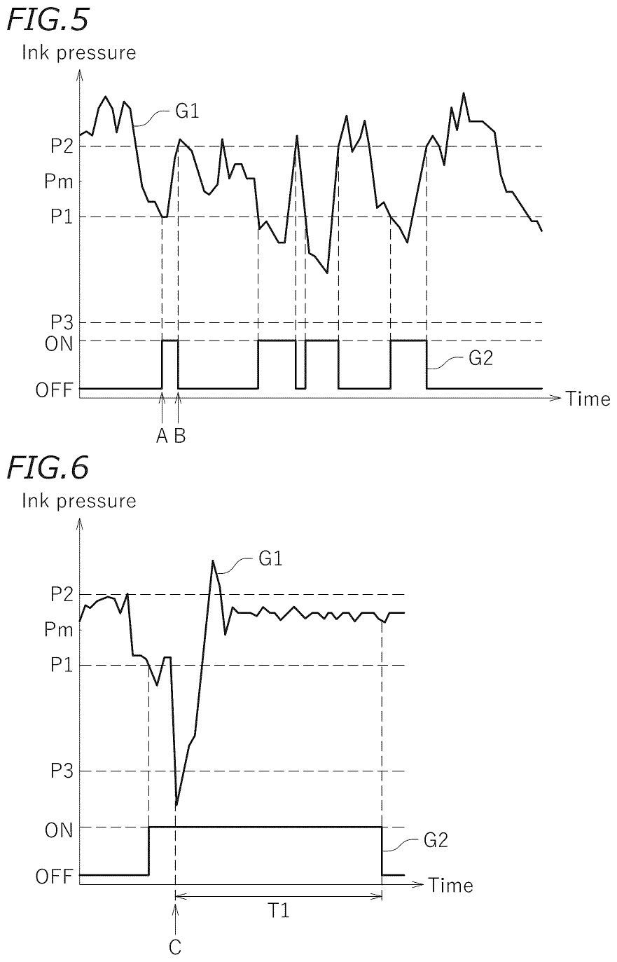

The threshold value registration section 102 is configured or programmed to have registered therein, the hit pressure P1, the unhit pressure P2, and the minimum pressure P3 (all shown in FIG. 5) that are predetermined for the pressure acquired by the pressure acquisition section 101. The hit pressure P1 is an example of the first threshold value. The hit pressure P1 is set to −2.1 kPa, for example. Note however that there is no particular limitation on the hit pressure P1 as long as it is in the vicinity of the pressure at which ink can form a meniscus at the nozzles 51 (e.g., a pressure that is within about 0.2 kPa below the pressure at which ink can form a meniscus). The unhit pressure P2 is set to a pressure that is greater than the hit pressure P1. The unhit pressure P2 is an example of the second threshold value. The unhit pressure P2 is set to about −1.9 kPa, for example. Note however that there is no particular limitation on the unhit pressure P2 as long as it is in the vicinity of the pressure at which ink can form a meniscus at the nozzles 51 (e.g., a pressure that is within about 0.2 kPa above the pressure at which ink can form a meniscus). The pressure Pm (see FIG. 5), which is exactly the midpoint between the hit pressure P1 and the unhit pressure P2, is herein about −2 kPa. The minimum pressure P3 is set to a pressure lower than the hit pressure P1. The minimum pressure P3 is an example of the third threshold value. The minimum pressure P3 is set to about −2.4 kPa, for example. Note however that the minimum pressure P3 is not limited to the pressure above.

The minimum pressure P3 may be changed by the operation of the printer 10 (e.g., printing operation, suction operation by a capping device not shown in the figures, flushing operation, operation of recovering from ink end detection to be described later, etc.). For example, the minimum pressure P3 may be set lower during the flushing operation than during the suction operation when cleaning the ink heads 50.

The first liquid pump control section 103 and the second liquid pump control section 104 are configured or programmed to control the liquid pump 63. The first liquid pump control section 103 is configured or programmed to control the operation of the liquid pump 63 during normal ink supply. The second liquid pump control section 104 is configured or programmed to control the operation of the liquid pump 63 when the ink level in the ink cartridge 61 becomes low.

The first liquid pump control section 103 is configured or programmed to drive the liquid pump 63 when the pressure acquired by the pressure acquisition section 101 falls below the hit pressure P1, and to stop the liquid pump 63 when the pressure acquired by the pressure acquisition section 101 exceeds the unhit pressure P2. The hit pressure P1 is the threshold value for driving the liquid pump 63. The unhit pressure P2 is the threshold value for stopping the liquid pump 63. By such a control of the first liquid pump control section 103, the ink pressure in the damper 65 repeatedly rises and falls around the midpoint pressure Pm (here, −2 kPa) between the hit pressure P1 and the unhit pressure P2, and generally remains within the pressure range between the hit pressure P1 and the unhit pressure P2. The midpoint pressure Pm between the hit pressure P1 and the unhit pressure P2 is the target value for ink pressure control.

The end diagnosis section 105 is configured or programmed to diagnose that the ink in the ink cartridge 61 is insufficient when the pressure acquired by the pressure acquisition section 101 falls below the minimum pressure P3. The end diagnosis section 105 is configured or programmed to diagnose that the ink in the ink cartridge 61 is insufficient also when the pressure acquired by the pressure acquisition section 101 remains at or below the unhit pressure P2 even after a predetermined time has elapsed while the liquid pump 63 is driven by the control of the first liquid pump control section 103. Hereinafter, the state in which the end diagnostic section 105 diagnoses that the ink in the ink cartridge 61 is insufficient will also be referred to as the ink end state. The ink end state is a state in which ink needs to be replenished. In the present example embodiment, the ink end state is diagnosed when at least one of the two judgment criteria described above is satisfied. Note however that the criteria for diagnosing the ink end state may be only one of the above. For example, depending on the state of the printer 10, the ink end state may be determined solely based on whether the ink pressure continues to be at or below the unhit pressure P2. For example, in the operation of recovering from the ink end state, it is not necessary to determine whether the ink pressure is below the minimum pressure P3, and it may be diagnosed that the ink in the ink cartridge 61 is insufficient based solely on the ink pressure continuing to be at or below the unhit pressure P2 for a predetermined time even though the liquid pump 63 is driven.

Note that when determining the ink end state based on the amount of time for which the ink pressure continues to be at or below the unhit pressure P2, the determination time may be varied depending on the operation of the printer 10 (printing operation, suction operation, flushing operation, operation of recovering from ink end detection, etc.). For example, the determination time may be set to be shorter during the flushing operation than during the suction operation when cleaning the ink heads 50.

The second liquid pump control section 104 is configured or programmed to drive the liquid pump 63 for a predetermined time T1 (see FIG. 6) after it is diagnosed by the end diagnosis section 105 that the ink in the ink cartridge 61 is insufficient. The second liquid pump control section 104 thus moves a portion of the ink remaining in the ink cartridge 61 and the ink channel 62 to the damper 65. In the present example embodiment, the predetermined time (hereinafter referred to also as the “post-end-detection drive time”) T1 is set to be longer than the time required for the carriage moving device 30 to move the ink heads 50 from one end of the printable range R1 to the other end. The time required for the carriage moving device 30 to move the ink heads 50 from one end of the printable range R1 to the other end is the maximum time required for one print scan. Note that the printer 10 according to the present example embodiment is configured to continue the print scan at the time of detecting the ink end state.

The following describes the operation of the ink supply system 60 of the printer 10 according to the present example embodiment. FIG. 5 is a time chart showing the ink pressure in the damper 65 (hereinafter referred to simply as the “ink pressure”, etc.) measured by the pressure sensor 66 and the operation of the liquid pump 63. The horizontal axis of FIG. 5 represents time. The vertical axis of FIG. 5 represents ink pressure (the graph G1) and the presence/absence of an instruction to drive the liquid pump 63 (the graph G2).

When ink is consumed due to ink ejection for printing or maintenance, the ink pressure decreases. As shown in FIG. 5, when the ink pressure falls below the hit pressure P1, the printer 10 drives the liquid pump 63 (for example, refer to the point in time A on the horizontal axis). Thus, ink is supplied to the damper 65, causing the ink pressure to rise. The printer 10 stops the liquid pump 63 when the ink pressure exceeds the unhit pressure P2 (for example, refer to the point in time B on the horizontal axis in FIG. 5). The liquid pump 63 is driven between the point in time A and the point in time B. Since the unhit pressure P2 is set to be greater than the hit pressure P1, the time between the point in time A and the point in time B is relatively long.

If driving/stopping the liquid pump 63 is controlled using the same threshold value (e.g., the midpoint pressure Pm between the hit pressure P1 and the unhit pressure P2) as with conventional methods, the ink pressure may exceed the threshold value Pm immediately after the liquid pump 63 is driven, and the ink pressure may fall below the threshold value Pm immediately after the liquid pump 63 is stopped. As a result, a problem may occur in which the liquid pump 63 is repeatedly driven and stopped at short intervals.

In contrast, with the printer 10 according to the present example embodiment, the unhit pressure P2, which is the threshold value for stopping the liquid pump 63, is greater than the hit pressure P1, which is the threshold value for driving the liquid pump 63. Therefore, when the liquid pump 63 is driven, the ink pressure does not immediately exceed the unhit pressure P2. Furthermore, when the liquid pump 63 is stopped, the ink pressure does not fall below the hit pressure P1 immediately. Therefore, the problem in which the liquid pump 63 is repeatedly driven and stopped at short intervals is less likely to occur.

FIG. 6 is a time chart showing the ink pressure in the damper 65 and the operation of the liquid pump 63 when the ink end state is reached. As ink is consumed and the ink level in the ink cartridge 61 becomes low, driving the liquid pump 63 no longer supplies ink to the damper 65. In the present example embodiment, as shown at the point in time C in FIG. 6, when the ink pressure falls below the minimum pressure P3, it is diagnosed that the ink in the ink cartridge 61 is insufficient. Note that it is diagnosed that the ink in the ink cartridge 61 is insufficient also when the ink pressure does not exceed the unhit pressure P2 even when a predetermined time elapses while the liquid pump 63 is driven by the control of the first liquid pump control section 103.

When the ink end state is detected as described above, a conventional printer would immediately stop the liquid pump and issue a warning prompting to replace the ink cartridge. In contrast, the printer 10 according to the present example embodiment drives the liquid pump 63 for a predetermined post-end-detection drive time T1 after the ink end state is diagnosed. As shown in FIG. 6, in the present example embodiment, even if the ink pressure becomes equal to or greater than the unhit pressure P2 by the driving of the liquid pump 63, the liquid pump 63 continues to be driven until the post-end-detection drive time T1 elapses. Thus, ink remaining in the ink cartridge 61 and ink in the ink channel 62 move to the damper 65. Therefore, as shown by the ink pressure during the post-end-detection drive time T1 in FIG. 6, the ink pressure in the damper 65 can be maintained at a pressure sufficient for ejecting ink for the time being.

The functions/effects that can be achieved by the printer 10 according to the present example embodiment will now be described.

The printer 10 according to the present example embodiment includes the pressure sensor 66 to measure the pressure of the ink in the storage chamber 65a of the damper 65. The controller 100 is configured or programmed to include the pressure acquisition section 101 configured or programmed to acquire the pressure of the ink in the storage chamber 65a from the pressure sensor 66, and the threshold value registration section 102 configured or programmed to register the hit pressure P1 as the first threshold value, and the unhit pressure P2 as the second threshold value, which is greater than the hit pressure P1. The first liquid pump control section 103 is configured or programmed to drive the liquid pump 63 when the pressure acquired by the pressure acquisition section 101 falls below the hit pressure P1, and to stop the liquid pump 63 when the pressure acquired by the pressure acquisition section 101 exceeds the unhit pressure P2.

With such a printer 10, it is possible to reduce or prevent the problem in which the liquid pump 63 is repeatedly driven and stopped at short intervals for the reason described above. Note that with a conventional printer that controls the driving/stopping of the liquid pump using a single control threshold value, one may consider unconditionally pumping ink by a predetermined amount or for a predetermined time in order to suppress the problem in which the liquid pump is repeatedly driven and stopped at short intervals. However, with such a control, the ink supply from the damper may become excessive, and the ink pressure may become excessively higher than the target pressure. Alternatively, where ink is pumped by a predetermined amount or for a predetermined time, ink pumping becomes intermittent, resulting in determining, for each ink pump, whether the next pump is necessary. Thus, delays in ink pumping may occur when the amount of ink to be pumped is large, for example.

By using the pressure sensor 66 of a continuous measurement method, instead of ON/OFF detection by a filler, there are advantages such that the control pressure (here, the hit pressure P1, the unhit pressure P2, and the minimum pressure P3) can be easily changed, and the ink pressure can be measured irrespective of the state of the damper 65 (with the filler method, accurate pressure detection is no longer possible if the damper membrane deteriorates or if the air enters the storage chamber).

In the present example embodiment, the minimum pressure P3 as the third threshold value, which is smaller than the hit pressure P1, is registered in the threshold value registration section 102. The controller 100 is configured or programmed to include the end diagnosis section 105 that diagnoses that the ink in the ink cartridge 61 is insufficient when the pressure acquired by the pressure acquisition section 101 falls below the minimum pressure P3. The end diagnosis section 105 is configured or programmed to diagnose that the ink in the ink cartridge 61 is insufficient also when the pressure acquired by the pressure acquisition section 101 is at or below the unhit pressure P2 even when a predetermined time elapses while the liquid pump 63 is driven by the control of the first liquid pump control section 103. With these configurations, it is possible to detect insufficiency of the ink in the ink cartridge 61 using the detection of the pressure sensor 66.

In the present example embodiment, the controller 100 is configured or programmed to include the second liquid pump control section 104 that drives the liquid pump 63 for a predetermined post-end-detection drive time T1 after the end diagnostic section 105 diagnoses that the ink in the ink cartridge 61 is insufficient. With such a configuration, as described above, even if the ink level in ink cartridge 61 is low, the ink pressure in the damper 65 can be maintained at a pressure sufficient for ejecting ink for the time being.

In the present example embodiment, the post-end-detection drive time T1 is set to be longer than the time required for the carriage moving device 30 to move the ink heads 50 from one end of the printable range R1 to the other end. With such a configuration, it is highly likely that an amount of ink sufficient for printing at least one scan can be supplied to the damper 65. Therefore, an appropriate ink pressure is likely to be maintained even during the scan at the time of reaching the ink end state, and ink ejection failure is unlikely to occur in said scan.

Some example embodiments of the present invention has been described above. However, the example embodiments described above are merely illustrative, and the technologies disclosed herein can be implemented in various other forms.

For example, while the ink channel 62 simply connects the ink cartridge 61 and the ink head 50 in the example embodiments described above, it may further include other elements, such as a circulating channel to prevent sedimentation of ink components, and a bubble separation device, for example. The configuration of the ink supply system is not limited to the above.

While the pressure sensor 66 is configured to transmit a signal corresponding to the measured pressure in the example embodiments described above, there is no limitation thereto. The pressure sensor may, for example, be configured to transmit a first signal when the measured pressure exceeds a first threshold value and to transmit a second signal when the measured pressure exceeds a second threshold value, and the pressure acquisition section of the controller may determine whether the ink pressure is below the first threshold value, between the first threshold value and the second threshold value, or above the second threshold value based on the combination of presence/absence of the first signal and the second signal.

There is no other limitation on the configurations of the inkjet printers according to example embodiments of the present disclosure unless specified otherwise. For example, the technologies disclosed herein can be used for flat-bed inkjet printers, or can also be used for devices that incorporate an inkjet printer as a part thereof, such as inkjet printers with cutting heads, for example.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An inkjet printer comprising:
an ink container to contain ink;
an ink head to eject ink;
an ink channel to connect the ink container and the ink head;
a liquid pump provided along the ink channel to pump ink in a direction from the ink container toward the ink head when driven;
an intermediate container provided downstream of the liquid pump along the ink channel and including a storage chamber to temporarily store ink;
a pressure sensor to measure an ink pressure in the storage chamber; and
a controller that is connected to the ink head, the liquid pump, and the pressure sensor; wherein
the controller is configured or programmed to include:
a first liquid pump control section configured or programmed to control the liquid pump;
a pressure acquisition section configured or programmed to acquire the ink pressure in the storage chamber from the pressure sensor; and
a registration section configured or programmed to have registered therein a first threshold value and a second threshold value greater than the first threshold value, for the pressure acquired by the pressure acquisition section; wherein
the first liquid pump control section is configured or programmed to drive the liquid pump when the pressure acquired by the pressure acquisition section falls below the first threshold value, and to stop the liquid pump when the pressure acquired by the pressure acquisition section exceeds the second threshold value.

2. The inkjet printer according to claim 1, wherein:
the registration section is configured or programmed to have registered therein a third threshold value smaller than the first threshold value; and
the controller is configured or programmed to include a diagnosis section configured or programmed to diagnose that ink in the ink container is insufficient when the pressure acquired by the pressure acquisition section falls below the third threshold value.

3. The inkjet printer according to claim 1, wherein:
the controller is configured or programmed to include a diagnosis section configured or programmed to diagnose that ink in the ink container is insufficient when the pressure acquired by the pressure acquisition section is at or below the second threshold value even after a predetermined time has elapsed while the liquid pump is driven by a control of the first liquid pump control section.

4. The inkjet printer according to claim 2, wherein the controller is configured or programmed to include a second liquid pump control section configured or programmed to drive the liquid pump for a predetermined time after it is diagnosed by the diagnosis section that ink in the ink container is insufficient.

5. The inkjet printer according to claim 4, further comprising:
a mover to move the ink head in a scanning direction; wherein
a printable range, over which an image can be formed by ink ejected from the ink head, is set with respect to the scanning direction; and
the predetermined time is set to be longer than a time required for the mover to move the ink head from one end of the printable range to the other end.
